(19) United States
(12) Patent Application Publication
(10) Pub. No.: US 2024/0161009 A1
(43) Pub. Date: May 16, 2024

(54) LEARNING DEVICE, LEARNING METHOD, AND RECORDING MEDIUM

(71) Applicant: NEC Corporation, Tokyo (JP)

(72) Inventors: Yuki NAKAGUCHI, Tokyo (JP); Dai Kubota, Tokyo (JP)

(73) Assignee: NEC Corporation, Tokyo (JP)

(21) Appl. No.: 18/384,178

(22) Filed: Oct. 26, 2023

(30) Foreign Application Priority Data
Nov. 10, 2022 (JP) 2022-180115

(51) Int. Cl. G06N 20/00

(52) U.S. Cl. CPC G06N 20/00

(57) ABSTRACT

In a learning device, the acquisition means acquires a next state and a reward as a result of an action. The calculation means calculates a state value of the next state using the next state and a state value function of a teacher model. The generation means generates a shaped reward from the state value. The policy updating means updates a policy of a student model using the shaped reward and a discount factor of the student model to be leaned. The parameter updating means updates the discount factor.

### TECHNICAL FIELD

The present disclosure relates to imitation learning in reinforcement learning.

### BACKGROUND ART

There is proposed a new method of reinforcement learning which uses imitation learning in learning policy. Imitation learning is a technique for learning policy. “Policy” is a model that determines a next action for a certain state. Among the imitation learning, the interactive imitation learning performs the learning of the policy with reference to the teacher model, instead of the action data. Several methods have been proposed as the interactive imitation learning, for example, a technique using a teacher's policy as a teacher model, or a technique using a teacher's value function as a teacher model. In addition, in the technique using the teacher's value function as a teacher model, there are a technique using the state value which is a function of the state as the value function, and a technique using the action value which is a function of the state and the action.

As an example of interactive imitation learning, Non-Patent Document 1 proposes a technique to learn a policy by introducing a parameter k to truncate a specific reward and performing reward shaping at the same time using a teacher model, when calculating a sum of expected discount rewards.

Non-Patent Document 1: Wen Sun, J. Andrew Bagnell, Byron Boots, “Truncated Horizon Policy Search: Combining Reinforcement Learning & Imitation Learning”, ICLR 2018

### SUMMARY

However, in the method of Non-Patent Document 1, there is a problem that an optimal student model cannot be learned in imitation learning of a policy. Further, since the parameter k is a discrete variable, there is also a problem that the calculation cost becomes large in order to appropriately adjust the parameter k.

One object of the present disclosure is to enable learning of an optimal policy of a student model in interactive imitation learning of policy in reinforcement learning.

According to an example aspect of the present invention, there is provided a learning device comprising:
an acquisition means configured to acquire a next state and a reward as a result of an action;
a calculation means configured to calculate a state value of the next state using the next state and a state value function of a first machine learning model;
a generation means configured to generate a shaped reward from the state value;
a policy updating means configured to update a policy of a second machine learning model using the shaped reward and a discount factor of the second machine learning model to be leaned; and
a parameter updating means configured to update the discount factor.

According to another example aspect of the present invention, there is provided a learning method executed by a computer, comprising:
acquiring a next state and a reward as a result of an action;
calculating a state value of the next state using the next state and a state value function of a first machine learning model;
generating a shaped reward from the state value;
updating a policy of a second machine learning model using the shaped reward and a discount factor of the second machine learning model to be leaned; and
updating the discount factor.

According to still another example aspect of the present invention, there is provided a recording medium storing a program, the program causing a computer to execute processing of:
acquiring a next state and a reward as a result of an action;
calculating a state value of the next state using the next state and a state value function of a first machine learning model;
generating a shaped reward from the state value;
updating a policy of a second machine learning model using the shaped reward and a discount factor of the second machine learning model to be leaned; and
updating the discount factor.

According to the present disclosure, it is possible to learn the optimal policy of the student model in imitation learning of the policy in reinforcement learning.

### BRIEF DESCRIPTION OF THE DRAWINGS

FIG. 1 is a block diagram showing a hardware configuration of a learning device according to a first example embodiment.

FIG. 2 is a block diagram showing a functional configuration of the learning device according to the first example embodiment.

FIG. 3 is a diagram schematically showing learning of a student model by the learning device.

FIG. 4 is a flowchart of student model learning processing by the learning device.

FIG. 5 is a block diagram showing a functional configuration of a learning device according to a second example embodiment.

FIG. 6 is a flowchart of processing by the learning device according to the second example embodiment.

### EXAMPLE EMBODIMENTS

Preferred example embodiments of the present disclosure will be described with reference to the accompanying drawings.

### Explanation of Principle

### (1) Imitation Learning

In a problem of reinforcement learning, the imitation learning learns the student model for finding the policy, using information from a teacher model which is an example. In this case, the teacher model may be any of human, animal, algorithm, or else. Since behavioral cloning, which a typical technique for imitation learning, only uses the state of the teacher model and historical data of the action, it is vulnerable to the states with little or no data. Therefore, when the learned student model is actually executed, the deviation from the teacher model is increased with time, and it can be used only for the short-term problem.

Interactive imitation learning is to solve the above problem by giving the student under learning the online feedback from the teacher model, instead of the teacher's history data. Examples of interactive imitation learning include DAgger, AggreVaTe, AggreVaTeD and the like. These interactive imitation learning will be hereinafter referred to “the existing interactive imitation learning”. In the existing interactive imitation learning, when the optimal policy of the student model subjected to the learning is deviated from the teacher model, it is not possible to learn the optimal policy of the student model.

### (2) Explanation of Terms

Before describing the method of the present example embodiment, related terms will be explained below.

### (2-1) Objective Function and Optimal Policy for Reinforcement Learning

The expected discount reward sum J[π] shown in equation (1) is typically used as the objective function of reinforcement learning.

J[π]≡ [symbol] ₚ_{ₒ}_{,T,π}[Σₜ₌₀^{∞}γ^{t}r(sₜ, aₜ)] (1)

In equation (1), the following reward function r is the expected value of the reward r obtained when action a is performed in state s.

r(s,a)≡ [symbol] _{p(r|s,a)}[r]

Also, the discount factor γ shown below is a coefficient for discounting the value when evaluating the future reward value at present.

γ∈[0,1)

In addition, the optimal policy shown below is a policy to maximize the objective function J.

π*≡argmax_{π∈Π}J[π]

### (2-2) Value Function

The value function is obtained by taking the objective function J[π] as a function of the initial state s₀ and the initial action a₀. The value function represents the expected discounted reward sum to be obtained in the future if the state or action is taken. The state value function and the action value function are expressed by the following equations (2) and (3). As will be described later, the state value function and the action value function when entropy regularization is introduced into the objective function J[π] are expressed by the following equations (2x) and (3x) including a regularization term.

State value function: V^{π}(s)≡_{T,π}[Σₜ₋₀^{∞}γ^{t}r(sₜ,aₜ)|S₀=s] (2)

With regularization : V^{π}(s)≡ [symbol] _{T,π}[Σₜ₌₀^{∞}γ^{t}(r(sₜ,aₜ)+β⁻¹H^{π}(sₜ))|s₀=s] (2x)

Action value function Q^{π}(s,a)≡ [symbol] _{T,π}[Σₜ₌₀^{∞}γ^{t}r(sₜ,aₜ)|s₀=s,a₀=a] (3)

With regularization Q^{π}(s,a)≡ [symbol] _{T,π}[Σₜ₋₀^{∞}γ^{t}(r(sₜ,aₜ)+β⁻¹H^{π}(sₜ))|s₀=s,a₀=a]−β⁻¹H^{π}(s₀) (3x)

Also, the optimal value function is obtained by the following equations.

$$\begin{matrix}{V}^{*} = {max}_{π} {V}^{π} = {V}^{{π}^{*}} \\ {Q}^{*} = {max}_{π} {Q}^{π} = {Q}^{{π}^{*}}\end{matrix}$$

### (2-3) Reward Shaping

Reward shaping is a technique to accelerate the learning by utilizing the fact that the objective function J is deviated only by a constant and the optimal policy π* does not change even if the reward function is transformed using any function Φ(s) (called “potential”) of the state s. A variant of the reward function is shown below. The closer the potential Φ(s) is to the optimal state value function V*(s), the more the learning can be accelerated.

r(s,a)→r_{Φ}(s,a)≡r(s,a)+γ [symbol] _{T(s′|s,a)}[Φ(s′)]−Φ(s)

### (3) THOR Method

An example of interactive imitation learning advanced from the existing interactive imitation learning is described in the following document (Non-Patent Document 1). The method in this document is hereinafter referred to as “THOR (Truncated HORizon Policy Search)”. Note that the disclosure of this document is incorporated herein by reference.

Wen Sun, J. Andrew Bagnell, Byron Boots, “Truncated Horizon Policy Search: Combining Reinforcement Learning & Imitation Learning”, ICLR 2018

In THOR, the objective function in reinforcement learning is defined as follows.

J^{(k)}[π]≡ [symbol] _{p,a, T,π}[Σₜ₌₀^{K}γ^{t}r_{V}_{^{e}}(sₜ,aₜ)]

THOR is characterized by such points that the temporal sum of the objective function is truncated at a finite value k (called “horizon”) and that the state value function V^{e} of the teacher model reward-shaped as the potential Φ.

In a case where the temporal sum of the objective function is not truncated by a finite value, i.e., in a case where the horizon k=∞, the optimal policy obtained is consistent with the optimal policy of the student model. However, in a case where the temporal sum of the objective function is truncated at a finite horizon k<∞, the reward shaping changes the objective function and the optimal policy deviates from the optimal policy of the student model. In particular, it has been shown in THOR that if the reward shaping is performed with the horizon k=0, it becomes the objective function of the existing interactive imitation learning (AggreVaTeD).

Also, THOR shows that if the reward-shaped objective function with setting the horizon to an intermediate value of 0 and infinite, i.e., 0<k<∞ is used, the larger the horizon k is, the closer the optimal policy will approach from the existing interactive imitation learning (k=0) to reinforcement learning (equivalent to k=∞), i.e., the optimal policy of the student.

Also, in THOR, learning becomes simpler as the horizon k (i.e., how many steps to consider) is smaller. Therefore, learning becomes simpler than reinforcement learning (k=∞), similarly to the existing interactive imitation learning (k=0).

Since the horizon k>0 in THOR, unlike the existing interactive imitation learning (k=0), it is possible to approach the optimal policy to the optimal policy of the student. However, since the horizon k is fixed and cannot be moved during learning and remains k<∞, even if the optimal policy can be made close to the optimal policy of the student, it cannot be made to reach the optimal policy of the student.

Concretely, the optimal policy of THOR

π*ₖ≡argmax_{π}J^{(k)}[π]

has the value of the objective function J which is lower than the optimal policy of the student

π*≡argmax_{π}J[π]

by

ΔJ=0(γ^{k}ϵ/(1−γ^{k}))

Note that “ε” is the difference between the teacher's value V^{e} and the student's optimal value V*, and is expressed by the following equation.

$$ϵ ≡ {‖ {V}^{*} - {V}^{e} ‖}_{∞} = {max}_{s} \vert {V}^{*} ( s ) - {V}^{e} ( s ) \vert$$

Therefore, the larger the horizon k is, the closer ΔJ approaches 0 and the optimal policy approaches the optimal policy of the student. However, the optimal policy π*ₖ of THOR will be lower in performance by ΔJ than the optimal policy π* for the student, unless the teacher's value function is coincident with the student's optimal value function (ε=0).

In THOR, the larger the horizon k is, the closer the optimal policy can approach the optimal policy of the student. However, it becomes difficult to learn. Therefore, in order to make the optimal policy of THOR reach the optimal policy of the student, it is necessary to find the horizon k suitable for each problem by repeating the learning from zero with changing the horizon k. However, there is a problem that the amount of data and the amount of calculation becomes enormous.

In detail, the horizon k is a discrete parameter, so it cannot be changed continuously. Each time the horizon k is changed, the objective function and the optimal value function change significantly. Since many algorithms to learn the optimal policy such as THOR and reinforcement learning are based on the estimation of the optimal value function or the estimation of the gradient of the objective function, the horizon k cannot be changed during the learning.

### (4) Method of the Present Example Embodiment

The inventors of the present disclosure have discovered that, when performing reward shaping using the teacher's state value function V^{e} as the potential Φ similarly to THOR, by lowering the discount factor γ from the true value (hereinafter referred to as “γ*”) to 0 instead of lowering the horizon k from ∞ to 0, the objective function of the existing interactive imitation learning is obtained.

Therefore, in the method of the present example embodiment, instead of truncating the temporal sum of the objective function with a finite horizon of 0<k<∞ as in THOR, the discount factor 0<γ<γ* is used to bring the optimal policy close to the optimal policy of the student. Specifically, in the method of the present example embodiment, the following objective function is used.

J_{γ}[π]≡ [symbol] ₚ_{ₒ}_{,T,π}[Σₜ₌₀^{∞}γ^{t}rᵥ_{^{e}}(sₜ,aₜ)]

Further, in the method of the present example embodiment, the following conversion equation (equation (4)) is used in the reward shaping. However, according to the general theory of reward shaping, the expected value for the state s′ is substituted by the realized value in the state s′ for practical use. It should be noted that although the discount factor γ is used in the above objective function, the true discount factor γ* is used in the equation for converting reward shaping shown in equation (4).

r_{V}_{^{e}}(s,a)=r(s,a)+γ* [symbol] _{T(s′|s,a)}[V^{e}(s′)]−V^{e}(s) (4)

In the method of the present example embodiment, it can be proved that the greater the discount factor γ is, the closer the optimal policy approaches from the existing interactive imitation learning (γ=0) to reinforcement learning (equivalent to γ=∞), i.e., the optimal policy of the student. An optimal policy

π*_{γ}≡argmax_{π}J_{γ}[π]

has a value of the objective function J lower than the optimal policy of the student

π*≡argmax_{π}J[π]

by

ΔJ=0(2(γ^{∞}−γ)ϵ/((1−γ)(1−γ*)

However, by letting the discount factor γ reach the true discount factor γ* (γ→γ*), ΔJ can be brought to zero (ΔJ→0).

Like horizon k in THOR, the smaller the discount factor γ is, the simpler the learning is. Therefore, the method of the present example embodiment is simpler to learn than reinforcement learning (equivalent to γ=γ*), as is the existing interactive imitation learning (γ=0). Further, since the discount factor γ is a continuous parameter and the discount factor γ can be continuously changed during learning while stabilizing learning, there is no need to re-learn from zero every time the horizon k is changed as in THOR.

In the method of the present example embodiment, the maximum entropy reinforcement learning can be applied. Maximum entropy reinforcement learning is a technique to improve learning by applying entropy regularization to the objective function. Specifically, the objective function including a regularization term is expressed as follows.

J[π]≡ [symbol] ₚ_{ₒ}_{,T,π}[Σₜ₌₀^{∞}γ^{t}(r(sₜ,aₜ)+β⁻¹H^{π(}sₜ))]

Note that the entropy of the policy π at state s is expressed as follows.

H^{π}(s)≡ [symbol] _{π(a,s)}[log π(a|s)]

Since the entropy is large as it is disordered, the policy will take wider actions. The inverse temperature β is a hyperparameter designating the weakness of the regularization, and β∈[0,∞]. The inverse temperature β=∞ results in no regularization.

The application of entropy regularization makes learning more stable. By continuously increasing the discount factor γ from 0 to the true discount factor γ*, it is possible to move to the objective function of reinforcement learning while stabilizing learning and to reach the optimal policy for students. The method of the present example embodiment does not need to find a suitable horizon k for each problem as in THOR, and it can be said that the method of the present example embodiment is upwardly compatible with THOR. In the method of the present example embodiment, the application of the entropy regularization is arbitrary, and it is not essential.

In the method of the present example embodiment, it can be shown that even if the discount factor γ changes slightly, the objective variable and the optimal value function change only slightly. Furthermore, by applying entropy regularization, as expressed in the following equation, it can be shown that the optimal policy changes only slightly even when the discount factor γ is changed.

π*(a|s)=e^{β(Q}^{^{e}}^{(s,a)-V}^{^{e}}^{(s))}

Therefore, the discount factor γ can be continuously changed during learning while stabilizing learning.

Further, in the method of the present example embodiment, since the objective function, the optimum value function, and the optimum policy change only slightly even if the inverse temperature β is slightly changed, it is possible to continuously change the inverse temperature β during learning while stabilizing the learning and to introduce or remove the entropy regularization. Therefore, even when entropy regularization is introduced for stabilization of learning, if an optimal policy without entropy regularization is finally desired, entropy regularization may be removed after the discount factor γ is raised to the true discount factor γ* with the entropy regularization.

### First Example Embodiment

Next, a learning device according to the first example embodiment will be described. The learning device 100 according to the first example embodiment is a device that learns a student model using the above-described method.

[Hardware configuration]

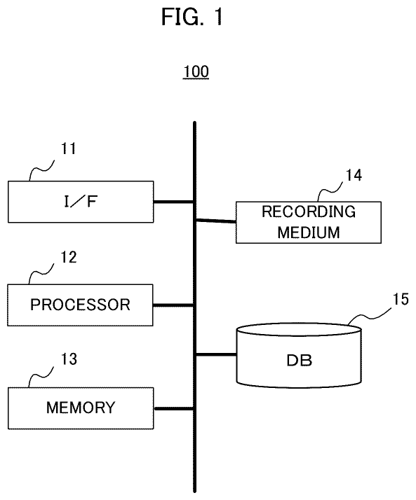

FIG. 1 is a block diagram illustrating a hardware configuration of a learning device 100 according to the first example embodiment. As illustrated, the learning device 100 includes an interface (I/F) 11, a processor 12, a memory 13, a recording medium 14, and a data base (DB) 15.

The I/F 11 inputs and outputs data to and from external devices. For example, when an agent by reinforcement learning of the present example embodiment is applied to an autonomous driving vehicle, the I/F 11 acquires the output of various sensors mounted on the vehicle as the state in the environment and outputs the action to various actuators controlling the travel of the vehicle.

The processor 12 is a computer, such as a CPU (Central Processing Unit), and controls the entire learning device 100 by executing a predetermined program. The processor 12 may be a GPU (Graphics Processing Unit) or a FPGA (Field-Programmable Gate Array). The processor 12 executes student model learning processing to be described later.

The memory 13 includes a ROM (Read Only Memory) and a RAM (Random Access Memory). The memory 13 is also used as a working memory during various processing operations by the processor 12.

The recording medium 14 is a non-volatile and non-transitory recording medium such as a disk-like recording medium, a semiconductor memory, or the like, and is configured to be detachable from the learning device 100. The recording medium 14 records various programs executed by the processor 12. When the learning device 100 executes various types of processing, the program recorded in the recording medium 14 is loaded into the memory 13 and executed by the processor 12.

The DB 15 stores data that the learning device 100 uses for learning. For example, the DB 15 stores data related to the teacher model used for learning. In addition, in the DB 15, data such as sensor outputs indicating the state of the target environment and inputted through the I/F 11 are stored.

### (Functional Configuration)

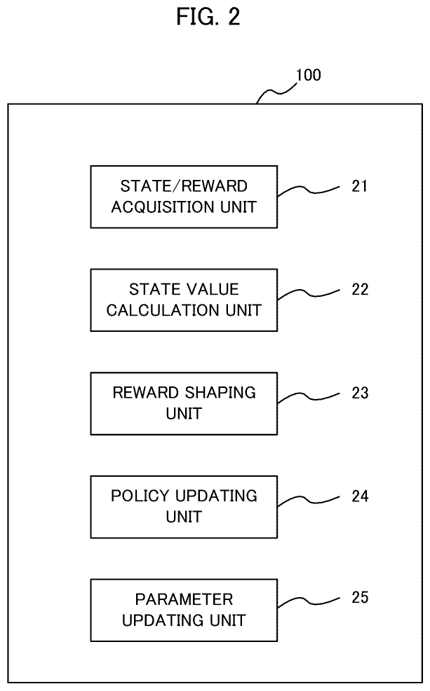

FIG. 2 is a block diagram illustrating a functional configuration of the learning device 100 according to the first example embodiment. The learning device 100 functionally includes a state/reward acquisition unit 21, a state value calculation unit 22, a reward shaping unit 23, a policy updating unit 24, and a parameter updating unit 25.

### (Learning Method)

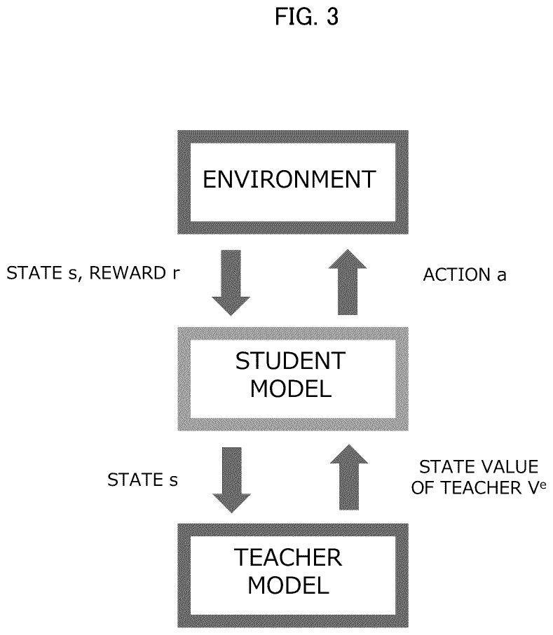

FIG. 3 is a diagram schematically illustrating learning of a student model by the learning device 100. As shown, the learning device 100 learns the student model through interaction with the environment and the teacher model. As a basic operation, the learning device 100 generates an action a based on the policy π of the current student model, and inputs the action a to the environment. Then, the learning device 100 acquires the state s and the reward r for the action from the environment. Next, the learning device 100 inputs the state s acquired from the environment into the teacher model, and acquires the state value V^{e} of the teacher from the teacher model. Next, the learning device 100 updates (hereinafter also referred to as “optimize”) the policy π using the acquired state value V^{e} of the teacher. The learning device 100 repeatedly executes this process until a predetermined learning end condition is satisfied.

### (Student Model Learning Processing)

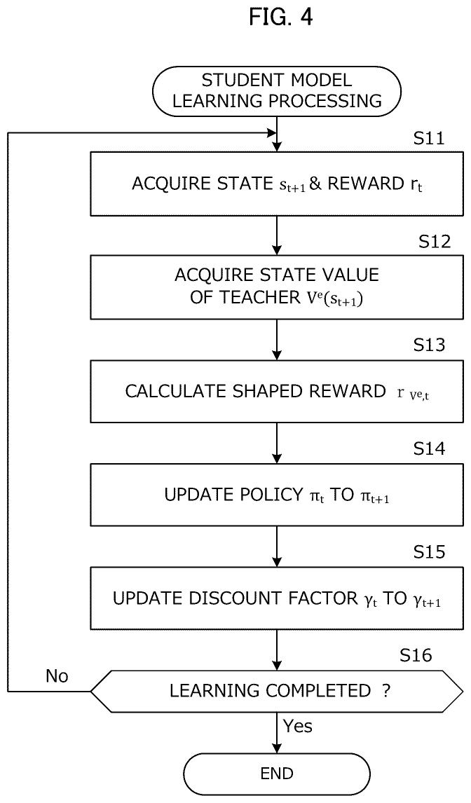

FIG. 4 is a flowchart of a student model learning processing performed by the learning device 100. This processing is realized by the processor 12 shown in FIG. 1, which executes a program prepared in advance and operates as the elements shown in FIG. 2.

First, the state/reward acquisition unit 21 generates aₜ action at based on the policy πₜ at the time, inputs the action aₜ to the environment, and acquires the next state sₜ₊₁ and the reward rₜ from the environment (step S11).

Next, the state value calculation unit 22 inputs the state sₜ₊₁ to the teacher model, and acquires the state value V^{e} (sₜ₊₁) of the teacher from the teacher model (step S12). For example, the state value calculation unit 22 acquires the state value V^{e}(sₜ₊₁) of the teacher using the learned state value function of the teacher given as the teacher model.

Next, the reward shaping unit 23 calculates the shaped reward r_{V}_{^{e}}_{,t} using the reward rₜ acquired from the environment and the state value V^{e}(sₜ), V^{e}(sₜ₊₁) of the teacher obtained from the teacher model (step S13). Specifically, the reward shaping unit 23 calculates the shaped reward using the previously-mentioned equation (4).

Next, the policy updating unit 24 updates the policy πₜ to πₜ₊₁ using the discount factor γₜ and the shaped reward r_{V}_{^{e}}_{,t} (step S14). As a method of updating the policy, various kinds of methods commonly used in reinforcement learning can be used.

Next, the parameter updating unit 25 updates the discount factor γₜ to γₜ₊₁ (step S15). Here, the parameter updating unit 25 updates the discount factor y to be close to the true discount factor γ* as described above. As one method, the parameter updating unit 25 determines the value of the discount factor γ in advance as a function of time t, and may update the discount factor γ using the function. Further, as another method, the parameter updating unit 25 may update the discount factor γ according to the progress of the learning of the student model.

Next, the learning device 100 determines whether or not the learning is completed (step S16). Specifically, the learning device 100 determines whether or not a predetermined learning end condition is satisfied. If the learning is not completed (step S16: No), the process returns to step S11, and steps S11 to S15 are repeated. On the other hand, when the learning is completed (step S16: Yes), the learning processing of the student model ends.

The above processing is directed to the case where entropy regularization is not introduced. When entropy regularization is introduced, in step S12, the state value calculation unit 22 acquires the state value V^{e}(sₜ₊₁) of the teacher using the state value function shown as the aforementioned equations (2) and (2x). Also, in step S14, the policy updating unit 24 updates the policy πₜ to πₜ₊₁ using the discount factor γₜ—, the inverse temperature βₜ, and the shaped reward r_{V}_{^{e}}_{,t}. Further, in step S15, the parameter updating unit 25 updates the discount factor γₜ to γₜ₊₁ and updates the inverse temperature βₜ to βₜ₊₁. Thus, when introducing entropy regularization, the learning device 100 performs learning while updating the inverse temperature β, in addition to the discount factor γ.

### [Effect]

According to the method of the present example embodiment, it is possible to efficiently learn the student model by utilizing the information of the teacher model similarly to the existing interactive imitation learning. In addition, the method of the present example embodiment can also learn the optimal policy of the student model, unlike the existing interactive imitation learning.

In THOR described above, it is necessary to repeat the learning from zero by changing the horizon k, which is a discrete variable, and find a suitable horizon k for each problem. In contrast, according to the method of the present example embodiment, since it is not necessary to redo the learning from zero in order to update the discount factor γ which is a continuous variable, efficient learning becomes possible.

In particular, the method of the present example embodiment has the advantage that the optimal policy can be learned efficiently when a teacher model, which is different from the optimal policy or whose coincidence with the optimal policy is unclear but whose behavior can be referred to, is available, e.g., in a case where the problems do not exactly match but are similar.

As an example, it is considered that the input information is incomplete and it is impossible or difficult to directly perform reinforcement learning. The case where the input information is incomplete is, for example, a case where there is a variable which cannot be observed, a case where there is noise in the observation, or the like. Even in such a case, in the method of the present example embodiment, the input information is perfect, and it is possible to perform reinforcement learning once in a simpler situation and to perform imitation learning of the student model in an incomplete situation by using it as a teacher model.

As another example, when the format of input information changes, such as changing a sensor, a large amount of data and time are required to perform reinforcement learning from zero with new input information. In such a case, in the method of the present example embodiment, data and time required for learning can be reduced by performing imitation learning using a model obtained by reinforcement learning using input information before the format changes, as the teacher model.

Alternatively, this example embodiment can also be applied to the medical/health care field. For example, the method of this example embodiment has the advantage that a diagnostic model for diagnosing a similar disease can be efficiently learned by using a previously learned diagnostic model for a specific disease as a teacher model.

For example, when the format of patient information changes, such as when the medical equipment is changed, a large amount of data and time are required to perform a diagnosis from the start using the new information. In such a case, in the method of the present example embodiment, a model learned based on diagnosis data using the patient information before the format change may be used as a teacher model and a diagnostic model corresponding to information in the new format can be learned.

### Second Example Embodiment

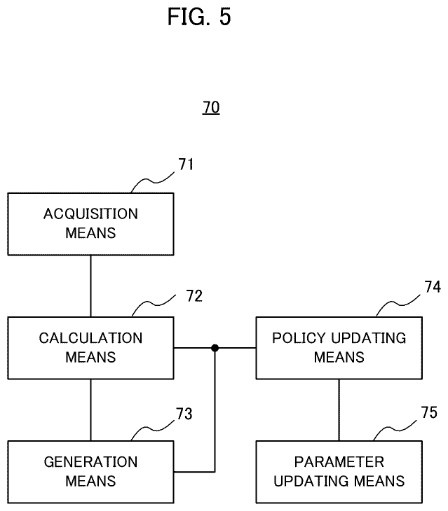

FIG. 5 is a block diagram illustrating a functional configuration of a learning device according to a second example embodiment. As illustrated, the learning device 70 includes an acquisition means 71, a calculation means 72, a generation means 73, a policy updating means 74, and a parameter updating means 75.

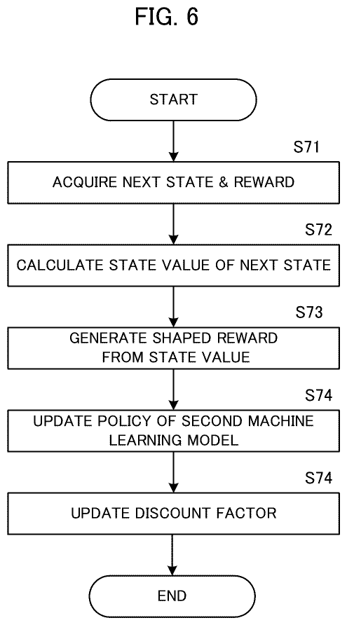

FIG. 6 is a flowchart of processing performed by the learning device according to the second example embodiment. The acquisition means 71 acquires a next state and a reward as a result of an action (step S71). The calculation means 72 calculates a state value of the next state using the next state and a state value function of a first machine learning model (step S72). The generation means 73 generates a shaped reward from the state value (step S73). The policy updating means 74 updates a policy of a second machine learning model using the shaped reward and a discount factor of the second machine learning model to be leaned (step S74). The parameter updating means updates the discount factor (step S75).

A part or all of the example embodiments described above may also be described as the following supplementary notes, but not limited thereto.

### (Supplementary Note 1)

A learning device comprising:
a memory configured to store instructions; and
a processor configured to execute the instructions to:
acquire a next state and a reward as a result of an action;
calculate a state value of the next state using the next state and a state value function of a first machine learning model;
generate a shaped reward from the state value;
update a policy of a second machine learning model using the shaped reward and a discount factor of the second machine learning model to be leaned; and
update the discount factor.

### (Supplementary Note 2)

The learning device according to Supplementary note 1,
wherein an objective function of the student model includes an entropy regularization term;
wherein the entropy regularization term includes an inverse temperature which is a coefficient indicating a degree of regularization,
wherein the policy updating means updates the policy of the student model using the shaped reward, the discount factor, and the inverse temperature, and
wherein the parameter updating means updates the inverse temperature.

### (Supplementary Note 3)

The learning device according to Supplementary note 1, wherein the parameter updating means optimizes the discount factor so as to approach a predetermined true value.

### (Supplementary Note 4)

The learning device according to Supplementary note 3, wherein the generation means generates the shaped reward using the true value as the discount factor.

### (Supplementary Note 5)

A learning method executed by a computer, comprising:
acquiring a next state and a reward as a result of an action;
calculating a state value of the next state using the next state and a state value function of a first machine learning model;
generating a shaped reward from the state value;
updating a policy of a second machine learning model using the shaped reward and a discount factor of the second machine learning model to be leaned; and
updating the discount factor.

### (Supplementary Note 6)

A recording medium storing a program, the program causing a computer to execute processing of:
acquiring a next state and a reward as a result of an action;
calculating a state value of the next state using the next state and a state value function of a first machine learning model;
generating a shaped reward from the state value;
updating a policy of a second machine learning model using the shaped reward and a discount factor of the second machine learning model to be leaned; and
updating the discount factor.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2022-180115, filed on Nov. 10, 2022, the disclosure of which is incorporated herein in its entirety by reference.

### DESCRIPTION OF SYMBOLS

12 Processor
21 State/reward acquisition unit
22 State value calculation unit
23 Reward shaping unit
24 Policy updating unit
25 Parameter updating unit

1. A learning device comprising:
a memory configured to store instructions; and
a processor configured to execute the instructions to:
acquire a next state and a reward as a result of an action;
calculate a state value of the next state using the next state and a state value function of a first machine learning model;
generate a shaped reward from the state value;
update a policy of a second machine learning model using the shaped reward and a discount factor of the second machine learning model to be leaned; and
update the discount factor.

2. The learning device according to claim 1,
wherein an objective function of the student model includes an entropy regularization term;
wherein the entropy regularization term includes an inverse temperature which is a coefficient indicating a degree of regularization,
wherein the processor updates the policy of the student model using the shaped reward, the discount factor, and the inverse temperature, and
wherein the processor updates the inverse temperature.

3. The learning device according to claim 1, wherein the processor optimizes the discount factor so as to approach a predetermined true value.

4. The learning device according to claim 3, wherein the processor generates the shaped reward using the true value as the discount factor.

5. A learning method executed by a computer, comprising:
acquiring a next state and a reward as a result of an action;
calculating a state value of the next state using the next state and a state value function of a first machine learning model;
generating a shaped reward from the state value;
updating a policy of a second machine learning model using the shaped reward and a discount factor of the second machine learning model to be leaned; and
updating the discount factor.

6. A non-transitory computer readable recording medium storing a program, the program causing a computer to execute processing of:
acquiring a next state and a reward as a result of an action;
calculating a state value of the next state using the next state and a state value function of a first machine learning model;
generating a shaped reward from the state value;
updating a policy of a second machine learning model using the shaped reward and a discount factor of the second machine learning model to be leaned; and
updating the discount factor.
